(19) United States
(12) Patent Application Publication
(10) Pub. No.: US 2014/0260287 A1
(43) Pub. Date: Sep. 18, 2014

(54) GAS TURBINE FIRING TEMPERATURE OPTIMIZATION BASED ON SULFUR CONTENT OF FUEL SUPPLY

(71) Applicant: GENERAL ELECTRIC COMPANY, Schenectady, NY (US)

(72) Inventors: Robert Thomas Thatcher, Greer, SC (US); Bradley Steven Carey, Greer, SC (US); Paul Burchell Glaser, Albany, NY (US); Ariel Harter Lomas, Simpsonville, SC (US); Andrew Mitchell Rodwell, Greenville, SC (US)

(73) Assignee: GENERAL ELECTRIC COMPANY, Schenectady, NY (US)

(21) Appl. No.: 13/832,270

(22) Filed: Mar. 15, 2013

(51) Int. Cl. F02C 7/30; G01N 25/02; F02C 9/00

(52) U.S. Cl. CPC F02C 7/30; F02C 9/00; G01N 25/02
USPC 60/772; 60/39.24; 374/27

(57) ABSTRACT

Gas turbine firing temperature optimization based on a measured sulfur content of a fuel supply of the gas turbine system is provided. In one embodiment, a system includes a diagnostic system configured to determine a maximum firing temperature for a combustor of a gas turbine system. The diagnostic system may determine the maximum firing temperature based on a predetermined sulfur content to maximum firing temperature correlation and an actual sulfur content of a fuel supplied to the combustor. The diagnostic system may also be configured to provide an indicator for a change in an actual firing temperature in the combustor of the gas turbine system. The diagnostic system may provide the indicator in response to the determined maximum firing temperature differing from the actual firing temperature of the combustor of the gas turbine system.

### BACKGROUND OF THE INVENTION

1. Technical Field

The disclosure is related generally to gas turbine systems. More particularly, the disclosure is related to gas turbine firing temperature optimization based on a measured sulfur content of a fuel supply of the gas turbine system.

2. Related Art

Conventional turbo machines, such as gas turbine systems, are utilized to generate power for electric generators. In general, gas turbine systems generate power by passing a fluid (e.g., hot gas) through a compressor and a turbine component of the gas turbine system. More specifically, inlet air may be drawn into a compressor and may be compressed. Once compressed, the inlet air is mixed with fuel to form a combustion product, which may be ignited by a combustor of the gas turbine system to form the operational fluid (e.g., hot gas) of the gas turbine system. The fluid may then flow through a fluid flow path for rotating a plurality of rotating buckets and shaft of the turbine component for generating the power. The fluid may be directed through the turbine component via the plurality of rotating buckets and a plurality of stationary nozzles positioned between the rotating buckets. As the plurality of rotating buckets rotate the shaft of the gas turbine system, a generator, coupled to the shaft, may generate power from the rotation of the shaft.

The efficiency of a conventional gas turbine system may, at least in part, be dependent on the firing temperature of the gas turbine system. That is, the power generated by the gas turbine system may be dependent upon the temperature in which the combustor ignites the combustion product to produce the operational fluid of the gas turbine system. Typically, the higher the firing temperature, the greater the power output the gas turbine system may achieve. However, as the firing temperature of the gas turbine increases, the production of unwashable ash may also increase. The unwashable ash may form within the turbine component of the gas turbine system as an undesirable by-product of the ignition of the combustion product when creating the operational fluid of the gas turbine system. The amount of sulfur present in the fuel has also been shown through analysis and testing to influence the production of unwashable ash. Unwashable ash cannot be removed from the turbine component during a water-washing process performed when the gas turbine system is not in operation (e.g., maintenance process). Rather, unwashable ash has to be removed by a mechanical process (e.g., grinding, scrapping), which may be expensive, time consuming and may cause damage to the components of the turbine component.

### BRIEF DESCRIPTION OF THE INVENTION

Gas turbine firing temperature optimization based on a sulfur content of a fuel supply of a gas turbine system is disclosed. In one embodiment, a system includes a diagnostic system configured to: determine a maximum firing temperature for a combustor of a gas turbine system based on a predetermined sulfur content to maximum firing temperature correlation and an actual sulfur content of a fuel supplied to the combustor; and provide an indicator for a change in an actual firing temperature in the combustor of the gas turbine system in response to the determined maximum firing temperature differing from the actual firing temperature of the combustor of the gas turbine system.

A first aspect of the invention includes a system having: a diagnostic system configured to: determine a maximum firing temperature for a combustor of a gas turbine system based on a predetermined sulfur content to maximum firing temperature correlation and an actual sulfur content of a fuel supplied to the combustor; and provide an indicator for a change in an actual firing temperature in the combustor of the gas turbine system in response to the determined maximum firing temperature differing from the actual firing temperature of the combustor of the gas turbine system.

A second aspect of the invention includes a gas turbine system having: a fuel tank in fluid communication with a combustor via a conduit; a gas turbine control system coupled to the combustor, the gas turbine control system configured to control the combustor of the gas turbine system; and a diagnostic system operably connected to the gas turbine control system, the diagnostic system configured to: determine a maximum firing temperature for the combustor of the gas turbine system based on a predetermined sulfur content to maximum firing temperature correlation and an actual sulfur content of a fuel supplied to the combustor; and provide an indicator for a change in an actual firing temperature in the combustor of the gas turbine system in response to the determined maximum firing temperature differing from the actual firing temperature of the combustor of the gas turbine system.

A third aspect of the invention includes a method for preventing unwashable ash build-up in a gas turbine system during operation. The method includes: determining a maximum firing temperature for a combustor of the gas turbine system based on a predetermined sulfur content to maximum firing temperature correlation and an actual sulfur content of a fuel supplied to the combustor; and providing an indicator for a change in an actual firing temperature in the combustor of the gas turbine system in response to the determined maximum firing temperature differing from the actual firing temperature of the combustor of the gas turbine system.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a schematic depiction of a gas turbine system including a system for firing temperature optimization according to various embodiments of the invention.

FIG. 2 shows a schematic depiction of a system for firing temperature optimization operably connected to a gas turbine system according to embodiments of the invention.

FIG. 3 shows a linear graph illustrating a predetermined sulfur content to maximum firing temperature correlation according to embodiments of the invention.

FIG. 4 shows a flow diagram illustrating processes of utilizing a system within a gas turbine system according to embodiments of the invention.

It is noted that the drawings of the invention are not necessarily to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As discussed herein, aspects of the invention relate to gas turbine systems. Specifically, aspects of the invention relate to gas turbine firing temperature optimization based on a measured sulfur content of a fuel supply of the gas turbine system.

Turning to FIG. 1, a schematic depiction of a gas turbine system 100 is shown according to embodiments of the invention. Gas turbine system 100 may be any conventional gas turbine system, now known or later developed, for generating power for such components as an electric generator. As such, a brief description of the gas turbine system 100 is provided for clarity. As shown in FIG. 1, gas turbine system 100 may include a compressor 102, a combustor 104 fluidly coupled to compressor 102 and a turbine component 106 fluidly coupled to combustor 104 for receiving a combustion product from combustor 104. Turbine component 106 may also be coupled to compressor 102 via shaft 108. Shaft 108 may also be coupled to device 110 to be powered, such as a generator for creating electricity during operation of gas turbine system 100.

During operation of gas turbine system 100, as shown in FIG. 1, compressor 102 may take in air (e.g., Airᵢₙₗₑₜ) and compress the inlet air before moving the compressed inlet air to the combustor 104. Once in the combustor 104, the compressed air may be mixed with a fuel. More specifically, as shown in FIG. 1, a fuel tank 112 may be in fluid communication with combustor 104 via conduit 114, for supplying fuel to combustor 104 to be mixed with the compressed inlet air to form a combustion product. As shown in FIG. 1, the fuel of fuel tank 112 may be supplied to combustor 104 via pump 115. As is known in the art, pump 115 may apply a force to pull fuel in fuel tank 112 to combustor 104 via conduit 114. As such, details of the operation of pump 115 for supplying fuel to combustor 104 is omitted for clarity. Additionally, it is understood that fuel of fuel tank 112 may be supplied to combustor 104 by any conventional mechanical device configured to move fluid (e.g., fuel) through a conduit (e.g., conduit 114) including, but not limited to, pumps, motors, and blowers.

Once formed, the combustion product may then be ignited by combustor 104 to create a hot-pressurized exhaust gas (hot gas) that flows through turbine component 106. The hot gas flows through turbine component 106, and specifically, passes over a plurality of buckets 116 coupled to shaft 108, and a plurality of stator nozzles 118 adjacent the plurality of buckets. The hot gas flows over the plurality of buckets 116, which rotates the plurality of buckets 116 and shaft 108 of gas turbine system 100, respectively. The plurality of stator nozzles 118 may aid in directing the hot gas through turbine component 106, and more specifically, may direct the hot gas from an upstream set of buckets 116 to a downstream set of buckets 116 to aid in the rotation of the plurality of buckets 116 and shaft 108. As shaft 108 of gas turbine system 100 rotates, compressor 102 and turbine component 106 turn to power device 110.

During the operation of gas turbine system 100, the function of combustor 104 may be controlled by gas turbine control system 120. As shown in FIG. 1, gas turbine control system 120 may be operably connected to combustor 104 (e.g., via wireless, hardwire, or other conventional means) and may control the fuel intake from fuel tank 112 to be mixed with the compressed air, and/or may control the firing temperature of combustor 104. More specifically, as shown in FIG. 1, gas turbine control system 120 may be operably connected to combustor 104 to control the firing temperature and may also be operably connected to pump 115 for controlling the fuel intake supplied to combustor 104. Gas turbine control system 120 may control the fuel intake supplied to combustor 104 by changing the force applied by pump 115 for drawing fuel through conduit 114 to combustor 104. By controlling the fuel intake and/or the firing temperature of combustor 104, gas turbine control system 120 may also control the amount of hot gas that may flow through turbine component 106 and cause the plurality of bucket 116 and shaft 108 to rotate. As a result, gas turbine control system 120 may control, at least in part, the overall power output of gas turbine system 100 during operation.

Also shown in FIG. 1, gas turbine control system 120 may be operably connected to a temperature gauge 122 positioned within combustor 104. Temperature gauge 122 may be configured as any conventional device for obtaining an actual firing temperature (FT_{Actual}) of combustor 104 including, but not limited to, thermometer, thermcouples, thermistors, pyrometer, infrared sensor, etc. As discussed herein, temperature gauge 122 may continuously measure and provide the actual firing temperature (FT_{Actual}) of combustor 104 to gas turbine control system 120 during operation of gas turbine system 100. It is understood, however, that the actual firing temperature (FT_{Actual}) of combustor 104 may be calculated by gas turbine control system 120. More specifically, gas turbine control system 120 may utilize a plurality of conventional sensors (not shown) configured to provide gas turbine control system 120 with operational characteristics of gas turbine system 100. These operational characteristics may include, but are not limited to: flow pressure within gas turbine system 100, exhaust gas temperature exiting gas turbine system 100, dimension of gas turbine system 100 and the respective components (e.g., buckets 116, stator nozzles 118), material composition of gas turbine system 100, etc. Using conventional algorithms, now known or later developed, and the operational characteristics of gas turbine system 100, gas turbine control system 120 may calculate the actual firing temperature (FT_{Actual}) of combustor 104.

The ignition of the combustion product (e.g., inlet air and fuel) within combustor 104 may produce an ash that may flow through turbine component 106. More specifically, the ignition of the combustion product at the high operational temperatures of gas turbine system 100 may create ash as well as the hot gas that may drive turbine component 106 during operation of gas turbine system 100. The ash may be formed as a result of an inhibiting process performed on the fuel supplied to gas turbine system 100. For example, corrosion of the components (e.g., buckets 116, stator nozzles 118) of gas turbine system 100 may occur as a result of vanadium being present in the fuel supplied and utilized by gas turbine system 100. As result, an inhibitor, such as magnesium, may be added to the fuel to prevent vanadium inhibition (e.g., corrosion). While the inhibitor (e.g., magnesium) may prevent vanadium inhibition in gas turbine system 100, the addition of the inhibitor in the fuel may result in the formation of ash in gas turbine system 100 when the fuel is ignited by combustor 104. As gas turbine system 100 operates for an extended period of time, the ash may substantially coat or build-up on the components (e.g., buckets 116, stator nozzles 118) of turbine component 106. That is, shaft 108, the plurality of buckets 116 and/or the plurality of stator nozzles 118 may develop a coating of ash around an outer surface of the respective components. As the ash-coating of the components (e.g., buckets 116, stator nozzles 118) of turbine component 106 increases in thickness, the operational efficiency of gas turbine component 106, and gas turbine system 100 as whole, may decrease. As a result, gas turbine system 100 may be periodically shut down, so the ash may be removed from the respective components of turbine component 106. In some instances the ash may be substantially washable, meaning the ash may be substantially removed from the components of turbine component 106 by a water-based high pressure washing process. In another instance, the ash may be substantially unwashable, meaning the ash may not be removed by a high pressure washing process (e.g., water soluble), but must be removed by any conventional mechanical material removal process including, but not limited to: grinding, scoring, abrasive jet machining, milling, etc.

In various embodiments, as shown in FIG. 1, gas turbine system 100 may also include a firing temperature optimization system 200. As shown in FIG. 1, firing temperature optimization system 200 may include a sensor 202 operably connected to a diagnostic system 204 (e.g., via wireless, hardwire, or other conventional means) of firing temperature optimization system 200. Sensor 202 of firing temperature optimization system 200 may measure the sulfur content of the fuel supplied to combustor 104 during operation of the gas turbine system 100. More specifically, sensor 202 may measure the sulfur content of the fuel in fuel tank 112 that may be provided to combustor 104 via conduit 114 to be mixed with the compressed inlet air to form a combustion product of gas turbine system 100. In an embodiment, as shown in FIG. 1, sensor 202 may be a fuel composition sensor configured to measure the sulfur content of the fuel supplied to combustor 104. In an alternative embodiment, sensor 202 may be any conventional sensor for measuring the sulfur content of the fuel supplied to combustor 104 including, but not limited to, a chromatography sensor and a mass spectrometry sensor.

As shown in FIG. 1, sensor 202 of firing temperature optimization system 200 may be positioned within conduit 114 in fluid communication with fuel tank 112 and combustor 104. As discussed herein, the fuel of fuel tank 112 may flow through conduit 114, via the operation of pump 115, to combustor 104 and may contact sensor 202, such that sensor 202 may measure the sulfur content of the fuel just prior to the fuel reaching combustor 104. As discussed herein, sensor 202 may be configured to measure the sulfur content of the fuel supplied to combustor 104 continuously, and may be configured to continuously provide the measured sulfur content data to diagnostic system 204 of firing temperature optimization system 200. In some embodiments firing temperature optimization system 200 may include a plurality of sensors 202 for measuring the sulfur content of the fuel supplied to combustor 104, as shown in phantom in FIG. 1. The plurality of sensors 202 may be positioned in various locations of gas turbine system 100. More specifically, firing temperature optimization system 200 may include sensor 202 positioned within conduit 114, sensor 202 positioned within fuel tank, and/or sensor 202 positioned within combustor 104. Where firing temperature optimization system 200 may include a plurality of sensors 202, sensor 202 may provide the measured sulfur content data to diagnostic system 204, and diagnostic system 204 may average the measured sulfur content data for further processing, as discussed herein. In an embodiment wherein sensor 202 may be positioned within combustor 104, sensor 202 may be positioned upstream of a combustor fuel nozzle (not shown) configured to mix the fuel of fuel tank 112 with the compressed inlet air of gas turbine system 100. In an alternative embodiment, sensor 202 may be configured to measure the sulfur content of the fuel supplied to combustor 104 at predetermined intervals, and may be configured to provide the measured sulfur content data to diagnostic system 204 of firing temperature optimization system 200.

In an embodiment, as shown in FIG. 1, firing temperature optimization system 200 may include diagnostic system 204 operably connected to sensor 202. As discussed herein, diagnostic system 204 may be configured to determine a maximum firing temperature (FTₘₐₓ) for combustor 104 of gas turbine system 100. More specifically, and as discussed herein, diagnostic system 204 may be configured to determine a maximum firing temperature (FT_{Max}) for combustor 104, which may include a firing temperature of combustor 104 for producing washable ash within gas turbine system 100 during operation. Additionally as discussed herein, diagnostic system 204 may be configured to provide an indicator to gas turbine control system 200 for a change in an actual firing temperature (FT_{Actual}) in combustor 104 of gas turbine system 100.

Turning to FIG. 2, a schematic depiction of firing temperature optimization system 200 is shown according to embodiments of the invention. In the Figures, it is understood that similarly numbered components may function in a substantially similar fashion. Redundant explanation of these components has been omitted for clarity. As shown in FIG. 2, diagnostic system 204 of firing temperature optimization system 200 may include a storage device 206, a sulfur content and firing temperature compare module 208 (“compare module 208,” hereafter), and an indicator module 210. Storage device 206 may be communicatively connected to compare module 208, and compare module 208 may be communicatively connected to indicator module 210. Diagnostic system 204 of firing temperature optimization system 200 may be communicatively connected to sensor 202 and may be configured to receive data relating to the sulfur content of the fuel supplied to gas turbine system 100 sensed by sensor 202. More specifically, and as discussed herein, compare module 208 may be configured to receive or obtain sulfur content data from sensor 202 relating to the amount of sulfur, measured, e.g., in parts-per-million (ppm), that may be present in the fuel supplied to combustor 104 during the operation of gas turbine system 100.

In an embodiment, as shown in FIG. 2, storage device 206 of diagnostic system 204 may store a predetermined sulfur content to maximum firing temperature correlation 212 (“P.C. 212,” hereafter)(as shown in phantom) for gas turbine system 100. In another embodiment, not shown, P.C. 212 may be stored on an external device and may be obtained and temporarily stored on storage device 206. P.C. 212 may include data defining a correlation between the sulfur content amount (ppm) in the fuel supplied to combustor 104, and the maximum firing temperature (FT_{Max}) in which combustor 104 may ignite the combustion product of gas turbine system 100 to substantially prevent the creation of unwashable ash in gas turbine system 100. Briefly turning to FIG. 3, the predetermined sulfur content to maximum firing temperature correlation 212 may be shown by a linear graph. More specifically, as shown in the graph illustrating P.C. 212, there may be a substantially linear correlation between sulfur content and the maximum firing temperature of gas turbine system 100. That is, as the sulfur content of the fuel supplied to combustor 104 rises, the firing temperature for combustor 104 may also rise, while substantially preventing the creation of unwashable ash during the operation of gas turbine system 100. However, it is understood that P.C. 212 may not be substantially linear, as shown in FIG. 3. That is, P.C. 212 may include a substantially logarithmic scale, an exponential curve, a bell curve, or any other conventional curvature representing the correlation between sulfur content and the maximum firing temperature of gas turbine system 100. The correlation line (L) may represent the correlation between sulfur content and a maximum firing temperature (FT_{Max}). As shown in FIG. 3, a firing temperature of combustor 104 that may be found on or substantially above the correlation line (L) may product washable ash during operation of gas turbine system 100. However, as shown in FIG. 3, a firing temperature of combustor 104 found substantially below the correlation line (L) may produce desirable unwashable ash, as discussed herein. Additionally, P.C. 212 may be represented or embodied in a variety of conventional data forms including, but not limited to, a look-up table, an algorithm, etc.

Returning to FIG. 2, compare module 208 of diagnostic system 204 may be configured to obtain or receive data (e.g., sulfur content) from sensor 202 and data (e.g., P.C. 212) from storage device 206, and may be configured to compare the data obtained therein. More specifically, compare module 208 may be configured to compare the actual sulfur content data of sensor 202 with P.C. 212 of storage device 206, and may determine a maximum firing temperature (FT_{Max}) for combustor 104 of gas turbine system 100. That is, compare module 208 may determine the maximum firing temperature (FT_{Max}) for combustor 104 by matching the actual sulfur content with a correlating firing temperature using, e.g., the linear graph (FIG. 3) for P.C. 212 of storage device 206.

Compare module 208 may also be configured to obtain or receive the actual firing temperature (FT_{Actual}) from gas turbine control system 120, and determine if the determined maximum firing temperature (FT_{Max}) differs from the actual firing temperature (FT_{Actual}). More specifically, compare module 208 of diagnostic system 204 may be operably connected to gas turbine control system 120, and may obtain or receive the actual firing temperature (FT_{Actual}) of combustor 104 which may be sensed by temperature gauge 122 of combustor 104. Compare module 208 may then compare and determine if the determined maximum firing temperature (FT_{Max}) differs from the actual firing temperature (FT_{Actual}).

Additionally, compare module 208 may be configured to transmit an indicator to indicator module 210 of diagnostic system 204 in response to determining that the determined maximum firing temperature (FT_{Max}) differs from the actual firing temperature (FT_{Actual}). More specifically, after determining the maximum firing temperature (FT_{Max}), and subsequently determining that the determined maximum firing temperature (FT_{Max}) differs from the actual firing temperature (FT_{Actual}), compare module 208 may transmit an indicator to indicator module 210, indicating that the determined maximum firing temperature (FT_{Max}) is greater than, or less than the actual firing temperature (FT_{Actual}).

Indicator module 210 of diagnostic system 204 may be configured to receive or obtain the indicator from compare module 208 in response to the determining that the determined maximum firing temperature (FT_{Max}) differs from the actual firing temperature (FT_{Actual}), and may provide an indicator for a change in actual firing temperature (FT_{Actual}) in combustor 104 of gas turbine system 100. More specifically, indicator module 210 may provide an indicator to gas turbine control system 120, indicating that a change in the actual firing temperature (FT_{Actual}) of combustor 104 in response to the determining that the determined maximum firing temperature (FT_{Max}) differs from the actual firing temperature (FT_{Actual}). The indicator provided by indicator module 210 may include providing instructions to gas turbine control system 120 to perform one of an increase or a decrease in the actual firing temperature (FT_{Actual}) of combustor 104.

In an embodiment, where the actual firing temperature (FT_{Actual}) is greater than the determined maximum firing temperature (FT_{Max}), the gas turbine system 100 may produce or create the undesirable, unwashable ash when igniting the combustion product. As such, the indicator provided by indicator module 210 may provide instructions to gas turbine control system 120 to decrease the actual firing temperature (FT_{Actual}) of combustor 104 to substantially equal the determined maximum firing temperature (FT_{Max}). In this example, by decreasing the actual firing temperature (FT_{Actual}) to equal the determined maximum firing temperature (FT_{Max}), combustor 104 of gas turbine system 100 may substantially prevent the production or creation of unwashable ash within gas turbine system 100 during operation. Additionally, gas turbine system 100 may operate at a maximum firing temperature (FT_{Max}), and therefore a maximum power output, that may substantially prevent the creation of unwashable ash in gas turbine system 100.

In an alternative embodiment, where the actual firing temperature (FT_{Actual}) is less than the determined maximum firing temperature (FT_{Max}), the gas turbine system 100 may not be operating at the maximum firing temperature (FT_{Max}) which may substantially prevent the production of unwashable ash during operation. As a result, gas turbine system 100 may not be generating a maximum power output, while still substantially preventing the production of unwashable ash in gas turbine system 100. As such, the indicator provided by indicator module 210 may provide instructions to gas turbine control system 120 to increase the actual firing temperature (FT_{Actual}) of combustor 104 to substantially equal the determined maximum firing temperature (FT_{Max}). In this example, by increasing the actual firing temperature (FT_{Actual}) to equal the determined maximum firing temperature (FT_{Max}), gas turbine system 100 may operate at a maximum power output while also substantially preventing the production or creation of unwashable ash during operation. It is understood that gas turbine control system 120 of gas turbine system 100 may increase or decrease the actual firing temperature (FT_{Actual}) of combustor 104 by changing the compositional ratio of fuel and compressed inlet air forming the combustion production of gas turbine system 100.

Diagnostic system 204, and its respective components (e.g., storage device 206, compare module 208, etc.), may be configured as any conventional data processing system (e.g., computer system) capable of receiving, temporarily storing and transmitting/forwarding data within the system and to external components coupled to the system (e.g., gas turbine control system 120). More specifically, diagnostic system 204 may be configured as any conventional hardware device (computer system controller), and the components of diagnostic system 204 (e.g., storage device 206, compare module 208, etc.) may be configured as software components stored within said computer system forming diagnostic system 204. In an example embodiment, diagnostic system 204 may be configured as a circuit board implemented on a conventional computer system, and may include associated software for performing the operational functions discussed herein. Additionally, diagnostic system 204 may be included within gas turbine control system 120. That is, diagnostic system 204, and gas turbine control system 120 may not be configured as separate components, but rather, diagnostic system 204 of firing temperature optimization system 200 may be integral (e.g., sub-system, installed computer program/system) with gas turbine control system 120.

Turning to FIG. 4, with continuing reference to FIGS. 2 and 3, a flow diagram is shown illustrating processes for preventing unwashable ash build-up in gas turbine system 100 during operation, according to embodiments of the invention. One illustrative process according to various embodiments can include the following processes:

Process P100: continuously measuring the sulfur content of the fuel supplied to combustor 104 of gas turbine system 100 during operation. As shown in FIG. 2, and discussed herein, the sulfur content of the fuel supplied to combustor 104 may be measured using firing temperature optimization system 200. More specifically, sensor 202 of firing temperature optimization system 200 may be positioned within conduit 114 and may be configured to measure the sulfur content of the fuel of fuel tank 112 as it is supplied to combustor 104 via conduit 114. As discussed herein, sensor 202 may be configured as any conventional sensor configured to measure the sulfur content of the fuel supplied to combustor 104 including, but not limited to, a fuel composition sensor, a chromatography sensor and a mass spectrometry sensor. Sensor 202 may measure the sulfur content of the fuel supplied to combustor 104, and may provide the data relating to the sulfur content of the fuel to firing temperature optimization system 200. Specifically, once measured, sensor 202 may provide the sulfur content data to compare module 208 of diagnostic system 204.

For example, the continuous measuring of the sulfur content in process P100 may include sensor 202 of firing temperature optimization system 200 continuously measuring the fuel supplied to combustor 104 of gas turbine system 100. In the example embodiment, as shown in FIG. 3, sensor 202 of firing temperature optimization system 200 may continuously measure the fuel supplied to combustor 104 (FIG. 2), and may determine the fuel includes a sulfur content of 300 ppm. After sensor 202 of firing temperature optimization system 200 determines the sulfur content of the fuel is 300 ppm, sensor 202 may provide the sulfur content data (e.g., 300 ppm) to compare module 208 of diagnostic system 204 for subsequent processing.

Following process P100, process P102 may include: determining a maximum firing temperature (FT_{Max}) for combustor 104 based on predetermined sulfur content to maximum firing temperature correlation (P.C.) 212. More specifically, determining the maximum firing temperature (FT_{Max}) for combustor 104 may be based on P.C. 212 and the measured or actual sulfur content of the fuel supplied to combustor 104. As discussed herein, the determining of the maximum firing temperature (FT_{Max}) may include identifying within P.C. 212 a firing temperature for combustor 104 that produces washable ash within gas turbine system 100 during operation. That is, as shown in FIG. 3, the determining of maximum firing temperature (FT_{Max}) may include identifying a point on the correlation line of P.C. 212 that is associated with the measured sulfur content in the y-axis, and then determining the firing temperature associated with the same point on the correlation line (L) of P.C. 212 in the x-axis.

Continuing the example from process P100, in process P102, compare module 208 may obtain or receive the sulfur content of the fuel being provided to combustor 104 (FIG. 2). More specifically, compare module 208 may receive from sensor 202 that the sulfur content of the fuel provided to combustor 104 (FIG. 2) is 300 ppm. As shown in FIG. 2, compare module 208 may then obtain or receive P.C. 212 from storage device 206 in order to determine maximum firing temperature (FT_{Max}) of gas turbine system 100. Then, as shown in FIG. 3, compare module 208 may utilize the linear graph of P.C. 212, and the obtained data about sulfur content being 300 ppm of the fuel, to determine that the maximum firing temperature (FT_{Max}) for combustor 104 of gas turbine system 100 (FIG. 2) is 1100° C.

Next, process P104 may include: determining if the determined maximum firing temperature (FT_{Max}) for combustor 104, as determined in process P102, differs from an actual firing temperature (FT_{Actual}) for combustor 104. More specifically, as shown in FIG. 2, gas turbine control system 120 may provide diagnostic system 204 with the actual firing temperature (FT_{Actual}) for combustor 104, as determined, e.g., by temperature gauge 122 positioned within combustor 104. Compare module 208 of diagnostic system 204 may obtain or receive the actual firing temperature (FT_{Actual}) from gas turbine control system 120, and may subsequently compare and determine if the determined maximum firing temperature (FT_{Max}) differs from the actual firing temperature (FT_{Actual}). Compare module 208 may compare the two obtained and/or determined firing temperatures and may determine that the determined maximum firing temperature (FT_{Max}) is one of: the same as the actual firing temperature (FT_{Actual}), greater than the actual firing temperature (FT_{Actual}), or less than the actual firing temperature (FT_{Actual}). As discussed herein, where the determined maximum firing temperature (FT_{Max}) for combustor 104 differs from the actual firing temperature (FT_{Actual}), compare module 208 may provide an indicator to indicator module 210 identifying whether the determined maximum firing temperature (FT_{Max}) is greater than or less the actual firing temperature (FT_{Actual}). Conversely, where compare module 208 determines the determined maximum firing temperature (FT_{Max}) is the same or equal to the actual firing temperature (FT_{Actual}), the processes for preventing unwashable ash build-up in gas turbine system 100 during operation may revert back to the beginning (e.g., P100).

Continuing the example, and with reference to FIGS. 2 and 3, temperature gauge 122 (FIG. 2) positioned within combustor 104 may determine that the actual firing temperature (FT_{Actual}) of combustor 104 is 1150° C. (FIG. 3). Gas turbine control system 120 operably connected to diagnostic system 204, and more specifically compare module 208, may obtain the actual firing temperature (FT_{Actual}) of combustor 104 (e.g., 1150° C.) from temperature gauge 122, and may provide the data to compare module 208. Compare module 208 may then compare and determine the determined maximum firing temperature (FT_{Max}) of 1100° C. is less than the actual firing temperature (FT_{Actual}) for combustor 104 (e.g., 1150° C.). That is, as shown in FIG. 3, the point associated with the actual firing temperature (FT_{Actual}) of combustor 104 in the linear graph of P.C. 212 at sulfur content 300 ppm is positioned below correlation line (L). More specifically, as shown in FIG. 3, the point associated with the actual firing temperature (FT_{Actual}) (e.g., 1150° C.) may be positioned in area of linear graph of P.C. 212 that may be associated with the production of undesirable, unwashable ash during the operation of gas turbine system 100. As a result, compare module 208 may examine P.C. 212 including the respective firing temperatures (e.g., FT_{Max}, FT_{Actual}), and may determine that the determined maximum firing temperature (FT_{Max}) of 1100° C. is less than the actual firing temperature (FT_{Actual}) for combustor 104 (e.g., 1150° C.) by 50° C.

Following process P104, process P106 may include: providing an indicator for a change in the actual firing temperature (FT_{Actual}) in response to the determined maximum firing temperature (FT_{Max}) differing from the actual firing temperature (FT_{Actual}). More specifically, as shown in FIG. 2, compare module 208 may obtain and compare the determined maximum firing temperature (FT_{Max}) and the actual firing temperature (FT_{Actual}), to determine if the determined maximum firing temperature (FT_{Max}) is one of: equal to, greater than or less than, the actual firing temperature (FT_{Actual}). If compare module 208 determines the determined maximum firing temperature (FT_{Max}) differs (e.g., greater than or less than) from the actual firing temperature (FT_{Actual}), compare module 208 provides an indicator to indicator module 210. As discussed herein, the indicator provided by compare module 208 may indicate that the determined maximum firing temperature (FT_{Max}) is one of: greater than, or less than, the actual firing temperature (FT_{Actual}). Indicator module 210, may receive or obtain the indicator from compare module 208, and may subsequently provide an indicator to gas turbine control system 120, indicating a change in the actual firing temperature (FT_{Actual}) in combustor 104 of gas turbine system 100. More specifically, the indicator provided by indicator module 210 may include instructions to gas turbine control system 120 to perform at least one of an increase or a decrease in the actual firing temperature (FT_{Actual}) of combustor 104, dependent on the results of the determining in process P104. As a result of indicator module 210 providing the indicator to gas turbine control system 120, gas turbine control system 120 may change (e.g., increase, decrease) the actual firing temperature (FT_{Actual}) of combustor 104 of gas turbine system 100, dependent upon the instructions provided within the indicator. Subsequent to the change in the actual firing temperature (FT_{Actual}), gas turbine system 100 may operate at a maximum firing temperature (FT_{Max}), and a maximum efficiency, while substantially preventing the production or creation of unwashable ash within gas turbine system 100.

Continuing the example, and with reference to FIGS. 2 and 3, compare module 208 may provide an indicator to indicator module 210 after determining the determined maximum firing temperature (FT_{Max}) of 1100° C. is less than the actual firing temperature (FT_{Actual}) for combustor 104 (e.g., 1150° C.). More specifically, compare module 208 may provide indicator module 210 with an indicator that the determined maximum firing temperature (FT_{Max}) is 50° C. less than the actual firing temperature (FT_{Actual}) for combustor 104, and a change in the actual firing temperature (FT_{Actual}) for combustor 104 is required. Indicator module 210 may receive the indicator from compare module 208, and may subsequently provide an indicator to gas turbine control system 120, instructing gas turbine control system 120 to decrease the actual firing temperature (FT_{Actual}) for combustor 104 by 50° C. After receiving or obtaining the indicator from compare module 208, gas turbine control system 120 may adjust the combustion product ratio (e.g., decrease the amount of fuel) accordingly, in order to decrease the actual firing temperature (FT_{Actual}) for combustor 104 by 50° C. As a result of the change, in the example embodiment, combustor 104 of gas turbine system 100 may subsequently operate at an adjusted, actual firing temperature (FT_{Actual}) of 1100° C. Based on the determined sulfur content and determined maximum firing temperature (FT_{Max}), the actual firing temperature (FT_{Actual}) of 1100° C. may generate the greatest output of power (e.g., greatest turbine efficiency), and may also substantially prevent the creation or production of unwashable ash within gas turbine system 100 during operation.

As discussed herein, the process (P100-P106) performed by firing temperature optimization system 200 may be continuously performed during the operation of gas turbine system 100. As such, firing temperature optimization system 200 may continuously perform the process described above, in order for gas turbine system 100 to operate at a firing temperature that may produce a maximum power output, without substantially producing unwashable ash during operation. Alternatively, the process (P100-P106) performed by firing temperature optimization system 200 may be performed at predetermined intervals during the operation of gas turbine system 100. As such, firing temperature optimization system 200 may perform the process described above in the predetermined intervals, in order for gas turbine system 100 to operate at firing temperature that may produce a maximum power output, without substantially producing unwashable ash during operation. Additionally, firing temperature optimization system 200 may perform the process described above in the predetermined intervals in order to substantially prevent operational stress to the components of gas turbine system 100 that may control the actual firing temperature (FT_{Actual}) of combustor 104 (e.g., gas turbine control system 120).

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A system comprising:
a diagnostic system configured to:
determine a maximum firing temperature for a combustor of a gas turbine system based on a predetermined sulfur content to maximum firing temperature correlation and an actual sulfur content of a fuel supplied to the combustor; and
provide an indicator for a change in an actual firing temperature in the combustor of the gas turbine system in response to the determined maximum firing temperature differing from the actual firing temperature of the combustor of the gas turbine system.

2. The system of claim 1, further comprising a sensor operably connected to the diagnostic system, the sensor for measuring the sulfur content of the fuel supplied to the combustor.

3. The system of claim 2, wherein the sensor is selected from a group consisting of: a fuel composition sensor, a chromatography sensor and a mass spectrometry sensor.

4. The system of claim 2, wherein the sensor one of: continuously measures the sulfur content of the fuel supplied to the combustor of the gas turbine system, or measures the sulfur content of the fuel supplied to the combustor at a predetermined interval.

5. The system of claim 2, wherein the sensor is positioned in the gas turbine system in a group consisting of: a conduit in fluid communication with the combustor, a fuel tank in fluid communication with the conduit, and the combustor, upstream of a combustor fuel nozzle configured to mix the fuel with compressed air of the gas turbine system.

6. The system of claim 1, further comprising a plurality of sensors operably connected to the diagnostic system.

7. The system of claim 1, wherein the determined maximum firing temperature of the combustor is a firing temperature for the combustor for producing washable ash within the gas turbine system during operation.

8. The system of claim 1, wherein the diagnostic system is operably connected to a gas turbine control system configured to control the combustor of the gas turbine system during operation.

9. The system of claim 8, wherein the indicator for changing the actual firing temperature further provides instructions to the gas turbine control system to perform at least one of an increase or a decrease in the actual firing temperature of the combustor.

10. A gas turbine system comprising:
a fuel tank in fluid communication with a combustor via a conduit;
a gas turbine control system operably connected to the combustor, the gas turbine control system configured to control the combustor of the gas turbine system; and
a diagnostic system operably connected to the gas turbine control system, the diagnostic system configured to:
determine a maximum firing temperature for the combustor of the gas turbine system based on a predetermined sulfur content to maximum firing temperature correlation and an actual sulfur content of a fuel supplied to the combustor; and
provide an indicator for a change in an actual firing temperature in the combustor of the gas turbine system in response to the determined maximum firing temperature differing from the actual firing temperature of the combustor of the gas turbine system.

11. The gas turbine system of claim 10, further comprising a sensor operably connected to the diagnostic system, the sensor for measuring the sulfur content of the fuel supplied to the combustor.

12. The gas turbine system of claim 11, wherein the sensor is selected from a group consisting of: a fuel composition sensor, a chromatography sensor and a mass spectrometry sensor.

13. The gas turbine system of claim 11, wherein the sensor is positioned in the gas turbine system in a group consisting of: a conduit in fluid communication with the combustor, a fuel tank in fluid communication with the conduit, or the combustor, upstream of a combustor fuel nozzle configured to mix the fuel with compressed air of the gas turbine system.

14. The gas turbine system of claim 11, wherein the sensor one of: continuously measures the sulfur content of the fuel supplied to the combustor of the gas turbine system, or measures the sulfur content of the fuel supplied to the combustor at a predetermined interval.

15. The gas turbine system of claim 10, wherein the determined maximum firing temperature of the combustor is a firing temperature for the combustor for producing washable ash within the gas turbine system during operation.

16. The gas turbine system of claim 10, wherein the indicator for changing the actual firing temperature further provides instructions to the gas turbine control system to perform at least one of an increase or a decrease in the actual firing temperature of the combustor.

17. A method for preventing unwashable ash build-up in a gas turbine system during operation, the method comprising:
determining a maximum firing temperature for a combustor of the gas turbine system based on a predetermined sulfur content to maximum firing temperature correlation and an actual sulfur content of a fuel supplied to the combustor; and
providing an indicator for a change in an actual firing temperature in the combustor of the gas turbine system in response to the determined maximum firing temperature differing from the actual firing temperature of the combustor of the gas turbine system.

18. The method of claim 17, wherein the determining of the maximum firing temperature of the combustor further includes identifying, within the predetermined sulfur content to maximum firing temperature correlation, a firing temperature for the combustor that produces washable ash within the gas turbine system during operation.

19. The method of claim 17, wherein the providing of the indicator for changing the actual firing temperature further includes providing instructions to a gas turbine control system to perform at least one of an increase or a decrease in the actual firing temperature of the combustor.

20. The method of claim 17, further comprising continuously measuring the actual sulfur content of the fuel supplied to the combustor of the gas turbine system using a sensor.
